(19) United States
(12) Patent Application Publication
(10) Pub. No.: US 2025/0110349 A1
(43) Pub. Date: Apr. 3, 2025

(54) HINGE FOR EYEGLASSES

(71) Applicant: VISOTTICA INDUSTRIE S.P.A., Susegana (IT)

(72) Inventor: Rinaldo MONTALBAN, Venezia (IT)

(21) Appl. No.: 18/895,418

(22) Filed: Sep. 25, 2024

(30) Foreign Application Priority Data
Sep. 29, 2023 (IT) 102023000020064

(51) Int. Cl. G02C 5/22

(52) U.S. Cl. CPC G02C 5/22

(57) ABSTRACT

Hinge for eyeglasses, which comprises a first articulation element provided with a base body provided with a slit, and a second articulation element comprising an engagement head placed in such slit and rotatably coupled to the first articulation element. The hinge also comprises an antifriction element, which is placed in the slit of the first articulation element and is provided with an abutment portion in abutment against the base body. The base body of the first articulation element is provided with a shaped engagement surface, and the abutment portion of the antifriction element is provided with a coupling surface counter-shaped with respect to the engagement surface and coupled in contact with the latter.

### FIELD OF APPLICATION

The present invention regards a hinge for eyeglasses.

The present hinge is advantageously intended to be employed in the production of eyeglass frames.

Therefore, the present hinge is inserted in the industrial sector of eyewear, i.e. of the production of eyeglass frames and of accessories and components for eyeglasses.

### STATE OF THE ART

As is known, in the eyewear sector, hinges are employed for articulating the temples to the front of a frame.

For such purpose, each hinge is conventionally formed by two articulation elements, pivoted to each other, of which a first element is fixed to a temple of the frame and a second element is fixed to a lateral portion of the front (also known with the term “end piece” in the technical jargon of the field).

More in detail, the first articulation element represents the female element of the hinge and comprises two first shoulders projecting from the temple, which delimit a slit between them. The shoulders of the first articulation element are respectively provided with first holes, of which an initial one is smooth and final one threaded, known as eyelets of the female articulation element of the hinge.

More in detail, the second articulation element represents the male element of the hinge and is provided with a second shoulder projecting from the end piece and having a second hole, commonly known as eyelet of the male element of the hinge. The second shoulder is arranged for being inserted in the slit delimited by the first shoulders.

The hinge also comprises a hinge screw employable in the eyelets of the articulation elements in order to rotatably couple them together and screwed to the threaded hole of one of the two first shoulders of the first articulation element (female).

In operation, the hinges allow the temples to rotate between a closed position, in which they are collected on the front of the eyeglasses, and an open position, in which they take on a substantially right angle position with respect to the front, adapted to allow the user to put on the eyeglasses.

One drawback of the hinges for eyeglasses of known type is due to the sliding friction which is extended between the shoulders of the two articulation elements, generally made of metal, since the aforesaid friction renders the hinges subjected to seizure phenomena, compromising the regular and correct operation thereof.

In order to resolve such drawback, techniques are known for lubricating the hinge, for example by means of oil, for the purpose of reduce the sliding friction between the articulation elements and, consequently, the friction of the hinge itself.

Nevertheless, the aforesaid oil lubrication techniques have in practice shown that they do not lack drawbacks.

A first drawback is due to the fact that the application of oil to the hinges during the steps of production of the eyeglasses involves the risk of dirtying other parts of the eyeglass frame, requiring the intervention of an operator in order to execute a subsequent cleaning step, which must be suitably executed so as to prevent the onset of stains and/or rings on the frame itself or on its container.

In order to overcome the abovementioned drawbacks, it has been sought to remedy by using hinges which do not require lubrication of the articulation elements.

For example, a technique of known type consists of the over-injection of a plastic material on the shoulder of the male articulation element of the hinge, in a manner such that the sliding between the shoulders of the two articulation elements occurs between the metal of the female articulation element and the over-injection attained on the male articulation element. More in detail, the material with which the over-injection is attained is for example polyamide PA66, and is placed, in liquid phase, on a die for plastic injection molding, and subsequently over-injected on the portion of the male element of the hinge.

Nevertheless, also the above-described over-injection technique has in practice demonstrated that it does not lack drawbacks.

A first drawback lies in the fact that, in particular in plastic frames, the male articulation element, on which the over-injection is made, is generally fixed to the end piece or to the temple by means of an embedding operation. During such operation, an anchorage portion of the articulation element is heated to a temperature greater than the melding temperature of the material with which eyeglass frame is made, (generally a polymer material such as for example acetate) and, then, it is inserted within the latter. The temperatures reached during such operation easily exceed 200° C., with the strong risk of deteriorating the plastic used for the over-injection and the consequent loss of operation of the latter.

So as to reduce the risk of deterioration of the plastic over-injection during the embedding operation, it is necessary to attain a conditioning system that maintains the shoulder of the male articulation element with the over-injection at an acceptable temperature, resulting in an increase of complexity and cost of the production process.

In addition, from the document GB 597,064, a hinge is known, provided with a metal fork placed between the shoulder of the male articulation element and the shoulders of the female articulation element in order to compensate for the clearance present between such shoulders and ensure a uniform friction of the hinge during its rotation.

In particular, the metal fork is provided with arms provided with corresponding holes aligned with the holes of the articulation elements in order to allow the passage of the hinge screw. In particular, along the holes of the arms, the fork is provided with flexible tongues adapted to be engaged with the hinge screw so as to prevent the loosening thereof.

In addition, the arms of the metal fork have an undulated profile so as to be able to be crushed, in order to be elastically adapted to the clearance between the shoulders.

The female articulation element is formed by two separate mirrored parts, each of which comprises one of the shoulders of such articulation element. In this manner, in order to assemble the hinge, it is necessary to place the metal fork around the shoulder of the male articulation element and then insert the latter between the two mirrored parts of the female articulation element. Subsequently, it is possible to fix together the two mirrored parts, for example by means of a screw, so as to compress, between the two shoulders of the female articulation element, the undulated arms of the metal fork and the shoulder of the male articulation element.

Nevertheless, also the latter solution of known type has shown that it does not lack drawbacks. A first drawback is represented by the fact that the aforesaid elastic fork must be employed with a female articulation element formed by two separate parts, since in its rest shape (not crushed) it results too wide to be inserted from the outside between the shoulders of the complete female articulation element.

Therefore, the metal fork can only be mounted during the final assembly of the hinge to the eyeglasses. This involves that the hinge producer must send the hinge completely loose to the eyeglass producer, with the risk of loss of several components during the logistics operations. In addition, the undulated shape of the arms of the hinge involves that there is always the possibility of clearance between the two articulation elements, with consequent instability of the hinge itself.

### PRESENTATION OF THE INVENTION

In this situation, the problem underlying the present invention is that of eliminating the drawbacks of the abovementioned prior art, by providing a hinge for eyeglasses that is provided with an antifriction element that can be simply and easily applied.

A further object of the present invention is to provide a hinge for eyeglasses that does not require the oil lubrication of the articulation elements.

A further object of the present invention is to provide a hinge for eyeglasses which has a correct friction grade between the two articulation elements.

A further object of the present invention is to provide a hinge for eyeglasses which allows an easy transport thereof (for example to the eyeglass producer) without risking the loss of components.

A further object of the present invention is to provide a hinge for eyeglasses which is easy to assembly for an eyeglass producer.

A further object of the present invention is to provide a hinge for eyeglasses that is structurally simple and inexpensive to attain.

### BRIEF DESCRIPTION OF THE DRAWINGS

The technical characteristics of the invention, according to the aforesaid objects, and the advantages thereof will be more evident from the following detailed description, made with reference to the enclosed drawings, which represent several merely exemplifying and non-limiting embodiments of the invention, wherein:

FIG. 1 shows a perspective view of an eyeglass frame in which the present hinge is mounted;

FIG. 2a shows a perspective view of the present hinge, according to a first embodiment of the present invention;

FIG. 2b shows an exploded view of the hinge of FIG. 2a;

FIGS. 2c and 2d show, respectively, a side view and a partially sectioned side view of the hinge of FIG. 2a;

FIGS. 2e and 2f show, respectively, an antifriction element and a first articulation element of the hinge of FIG. 2a;

FIG. 3 shows a perspective view of a variant of the hinge of FIG. 2a;

FIGS. 4a and 4b show a second embodiment of the hinge, object of the present invention, respectively, in a perspective view (FIG. 4a) and in an exploded view (FIG. 4b);

FIGS. 4c and 4d show, respectively, a side view and a partially sectioned side view of the hinge of FIG. 4a;

FIGS. 4e and 4f show, respectively, the antifriction element and the first articulation element of the hinge of FIG. 4a;

FIG. 5 shows a perspective view of a variant of the hinge of FIG. 4a;

FIGS. 6a and 6b show a third embodiment of the hinge, object of the present invention, respectively, in a perspective view (FIG. 6a) and in an exploded view (FIG. 6b);

FIGS. 6c and 6d show, respectively, a side view and a partially sectioned side view of the hinge of FIG. 6a;

FIGS. 6e and 6f show, respectively, the antifriction element and the first articulation element of the hinge of FIG. 6a;

FIG. 7 shows a perspective view of a variant of the hinge of FIG. 6a;

FIGS. 8a and 8b show a fourth embodiment of the hinge, object of the present invention, respectively, in a perspective view (FIG. 8a) and in an exploded view (FIG. 8b);

FIGS. 8c and 8d show, respectively, a side view and a side view, partially sectioned, of the hinge of FIG. 8a;

FIGS. 8e and 8f show, respectively, a perspective view and a side view, partially sectioned, of the hinge of FIG. 8a provided with an identification device TAG;

FIGS. 8g and 8h show, respectively, the antifriction element and the first articulation element of the hinge of FIG. 4a;

FIG. 9 shows a perspective view of a variant of the hinge of FIG. 8a;

FIG. 10 shows a partially sectioned side view of a fifth embodiment of the hinge, object of the present invention.

### DETAILED DESCRIPTION OF A PREFERRED EMBODIMENT

With reference to the enclosed drawings, reference number 1 overall indicates the hinge for eyeglasses, object of the present invention.

The hinge 1, according to the present invention, is intended to be employed for the attainment of frames 10 for eyeglasses of any type, in particular, whether the frames are made of metal, of polymer material, e.g. of acetate, or made of materials suitable for being processed by means of 3D printing (in particular nylon).

The hinge 1 is adapted to mutually articulate, in a per se known and conventional manner, two parts of the eyeglass frame 10 with each other.

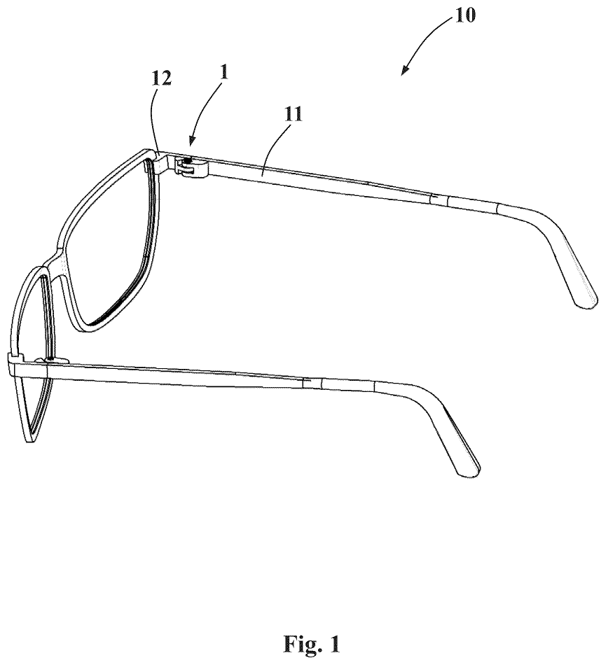

More in detail, with reference to the example of FIG. 1, the frame 10 comprises, in a per se conventional manner, a front provided with two annular portions (or “rims”) adapted to support corresponding lenses and connected in the central part by a bridge, and a pair of temples pivoted by means of hinges to the sides of the front and, more precisely, to two lateral portions thereof directed towards the upper part of the eyeglasses and known in the technical jargon of the field with the term end piece.

In operation, the temples can be moved, due to the aforesaid hinges, between a closed position, in which they are collected on the front of the frame 10, and an open position, in which the temples take on a substantially right angle position with respect to the front.

The hinge 1 for eyeglasses, object of the present invention, comprises a first articulation element 2, which is intended to be mounted on a first component 11 of an eyeglass frame 10, and comprises a base body 20 and two first shoulders 21, which are extended projectingly from the base body 20 parallel to each other, between them defining a slit 22, and are provided with corresponding first holes 23 that are aligned with each other.

The hinge 1 for eyeglasses also comprises a second articulation element 3, which is intended to be mounted on a second component 12 of the eyeglass frame 10, and comprises an engagement head 32 provided with at least one second hole 33 and placed in the slit 22 of the first articulation element 2 (in particular between the first shoulders 21 of the latter) with the second hole 33 aligned with the first holes 23 of the first articulation element 2 itself.

Preferably, the first and the second articulation element 2, 3 are made of metal material, e.g. alpacca/nickel silver, steel or titanium.

Advantageously, in accordance with the example reported in the enclosed figures, the first component 11 of the eyeglass frame 10 corresponds with one of the temples of the frame 10 and the second component 12 of the eyeglass frame 10 corresponds with the front of the frame 10 itself.

Hereinbelow, reference will be made to the preferred solution of the enclosed figures wherein the first component 11 of the eyeglass frame 10 is in fact constituted by a temple and the second component 12 is constituted by the front of the frame 10, nevertheless able to provide for embodiments where the two components are reversed, and in particular embodiments where the first articulation element 2 is mounted on the front and the second articulation element 3 is mounted on the temple, without departing from the protective scope of the present patent. The hinge 1 for eyeglasses also comprises an antifriction element 4 which is provided with an abutment portion 40 and with two arms 41, which are extended projectingly from the abutment portion 40 parallel to each other and spaced from each other, and are provided with corresponding third holes 43 that are aligned with each other.

The antifriction element 4 is placed in the slit 22 of the first articulation element 2 with the abutment portion 40 in abutment against the base body 20, with each arm 41 interposed between a corresponding first shoulder 21 of the first articulation element 2 and the engagement head 32 of the second articulation element 3, and with the third hole 43 aligned with the first holes 23 and with the second hole 33.

In this manner, the arms 41 of the antifriction element 4 prevent the engagement head 32 of the second articulation element 3 from being in direct contact with the first shoulders 21 of the first articulation element 2, thus preventing the development of a high friction between the first shoulders 21 and the engagement head 32 during the opening and the closing of the hinge 1, so as to prevent the seizure of the latter.

The hinge 1 for eyeglasses also comprises a hinge pin 5, which is inserted in the first holes 23 of the first shoulders 21 of the first articulation element 2, in the second hole 33 of the engagement head 32 of the second articulation element 3 and in the third holes 43 of the arms 41 of the antifriction element 4, and rotatably couples the first articulation element 2 and the second articulation element 3 around a rotation axis W passing through the first holes 23, the second hole 33 and the third holes 43.

Such hinge pin 5 for example comprises a screw, which, in a per se known manner, is provided with a head placed in abutment against one of the first shoulders 21, and with a threaded stem inserted in the first holes 23 and in the second hole 33 and engaged via screwing with the first hole 23 of the first shoulder 21 opposite that on which the head of the screw is abutted. For such purpose, in particular, the first hole 23 of the first shoulder 21, on which the head of the screw is abutted, is through and smooth, and the first hole 23 of the first shoulder 21 in which the stem of the screw is screwed, is threaded and optionally blind.

Advantageously, the first articulation element 2 is actuatable to be rotated (with relative motion with respect to the second articulation element 3) around the rotation axis W, in a closure sense in order to move the hinge 1 from the open position to the closed position, and in an opposite opening sense in order to move the hinge 1 from the closed position to the open position.

In accordance with the idea underlying the present invention, the base body 20 of the first articulation element 2 is provided with a shaped engagement surface 24, and the abutment portion 40 of the antifriction element 4 is provided with a coupling surface 44, which is counter-shaped with respect to the engagement surface 24 and is coupled in contact with the engagement surface 24.

In addition, the engagement surface 24 of the base body 20 is provided with a first abutment face 25 extended between the first shoulders 21 and a rear delimitation of the slit 22, and with a second abutment face 26 adjacent to the first abutment face 25, tilted with respect to the latter and placed outside the slit 22.

In addition, the coupling surface 44 of the abutment portion 40 is provided with a first abutting face 45 placed in abutment against the first abutment face 25, and with a second abutting face 46 adjacent to the first abutting face 45, tilted with respect to the first abutting face 45 and placed in abutment against the second abutment face 26.

In this manner, the shape of the engagement surface 24 of the base body 20 and the coupling surface 44 of the abutment portion 40 prevents the rotation of the antifriction element 4 with respect to the first articulation element 2 during the temple opening and closing operations. In particular, the tilt, respectively, of the second abutment face 26 with respect to the first abutment face 25 and of the second abutting face 46 with respect to the first abutting face 45, allows the antifriction element 4 to remain integral with the first articulation element 2. Preferably, the first shoulders 21 of the first articulation element 2 are extended projecting from the base body 20 starting from the first abutment face 25 of the engagement surface 24. Advantageously, the slit 22 is (completely) closed at the rear part, and in particular is (completely) closed by the first abutment face 25 of the engagement surface 24.

Preferably, the base body 20 is closed on an external side thereof that, when the hinge 1 is in open position, is directed opposite the external side of the base body 20 of the first articulation element 2 of the other hinge 1 (in open position of the eyeglasses).

Advantageously, the first shoulders 21 of the first articulation element 2 comprise corresponding internal faces 210, which are directed towards each other and are spaced from each other, between them delimiting the slit 22 between the first shoulders 21.

Preferably, each first shoulder 21 of the first articulation element 2 is provided with an external face 211 directed opposite the internal face 210, and with a first external surface 212, which is extended along the rotation axis W to connect between the internal face 210 and the external face 211, to define the thickness of the first shoulder 21 itself.

Advantageously, the engagement head 32 of the second articulation element 3 comprises two lateral faces 320, each of which directed towards the corresponding arm 41 of the antifriction element 4.

Preferably, each arm 41 of the antifriction element 4 is provided with a first abutting face 42 facing and placed in contact with the internal face 210 of the corresponding first shoulder 21, and with a second abutting face 42′ facing and placed in contact with the corresponding lateral face 320 of the engagement head 32.

In particular, the two arms 41 delimit a first slit 412 between the corresponding second abutting faces 42′, within which the engagement head 32 of the second articulation element 3 is placed. Advantageously, each arm 41 is substantially plate-like, with thickness that is particularly reduced with respect to the other two dimensions.

Preferably, the first and second abutting faces 42, 42′ of each arm 41 are substantially flat and orthogonal to the rotation axis W, in particular, in a manner such to adhere, respectively, to the internal faces 210 of the first shoulders 21 and to the lateral faces 320 of the engagement head 32, these too advantageously flat and orthogonal to the rotation axis W.

Advantageously, the first and the second abutment faces 25, 26 of the engagement surface 24 of the base body 20 of the first articulation element 2 are placed adjacent as a continuation of each other.

Advantageously, the first and the second abutment face 25, 26 of the engagement surface 24 of the base body 20 of the first articulation element 2 between them define a first coupling angle (different from) 180°, and the first and the second abutting faces 45, 46 of the coupling surface 44 of the abutment portion 40 of the antifriction element 4 between them define a second coupling angle which is conjugate with respect to the aforesaid first coupling angle (different from) 180°.

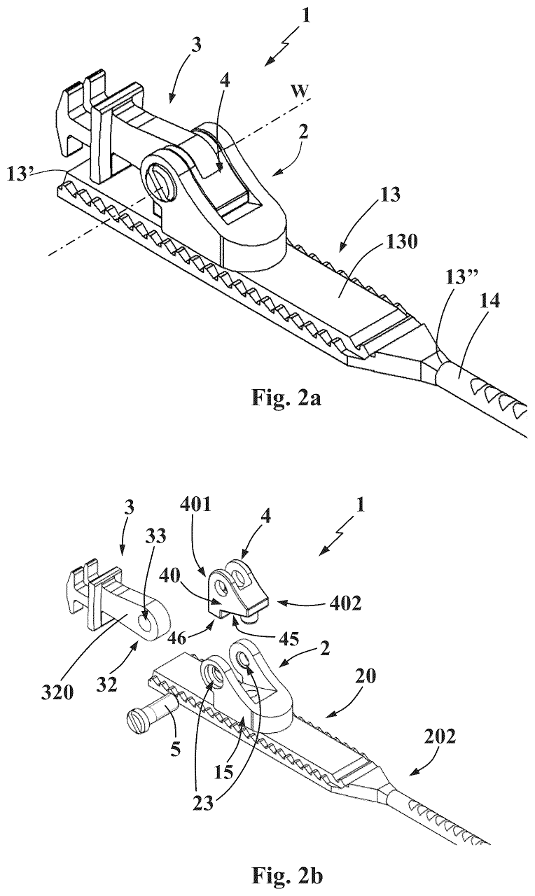

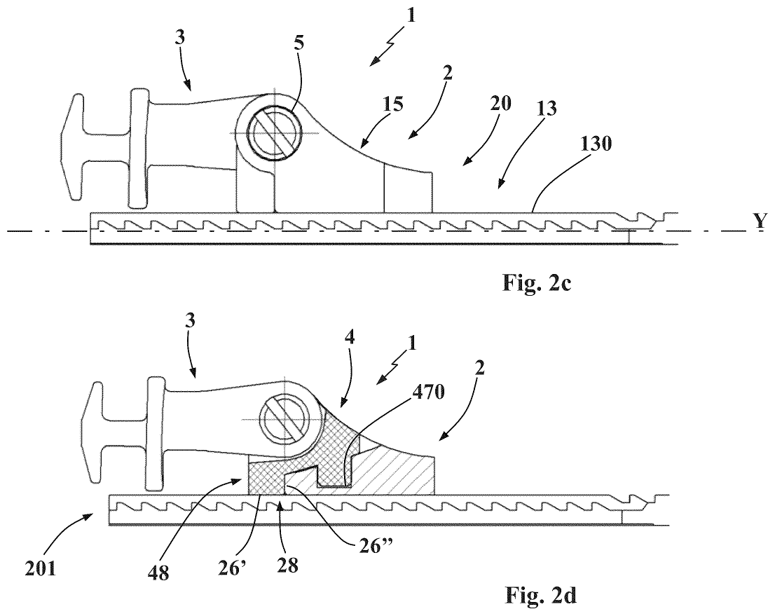

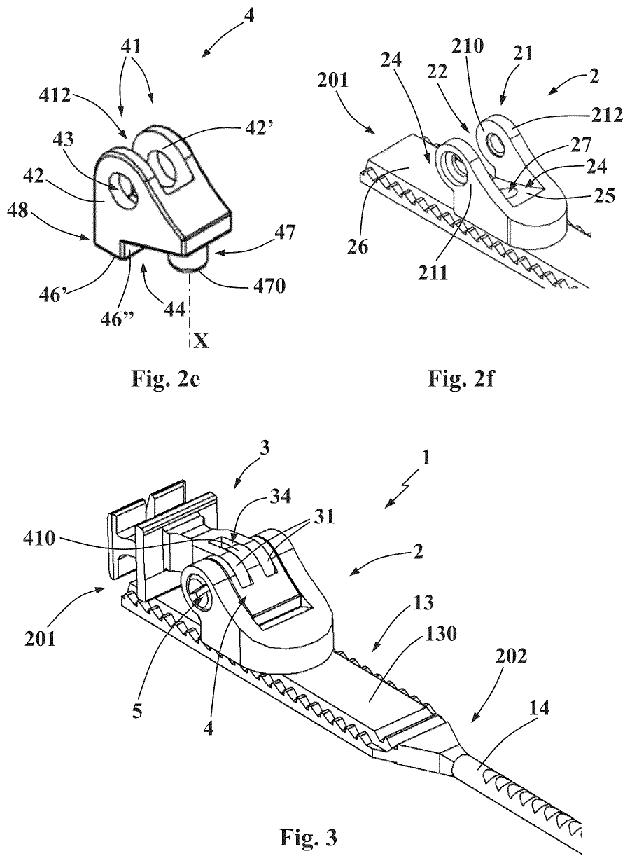

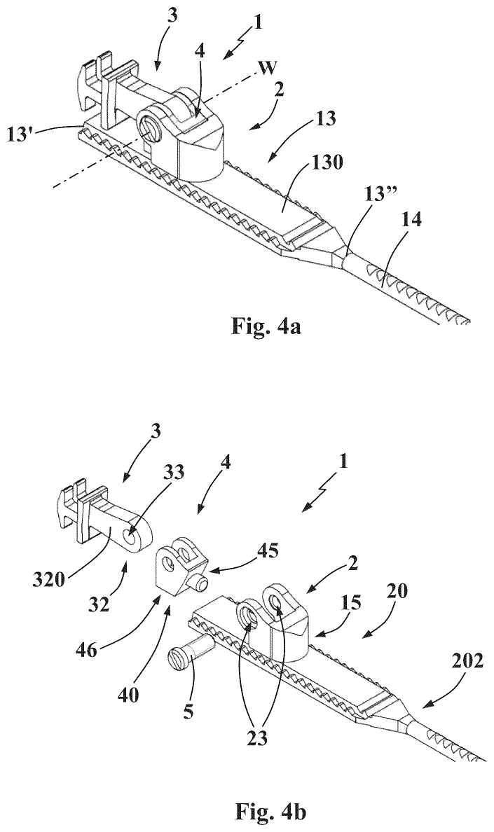

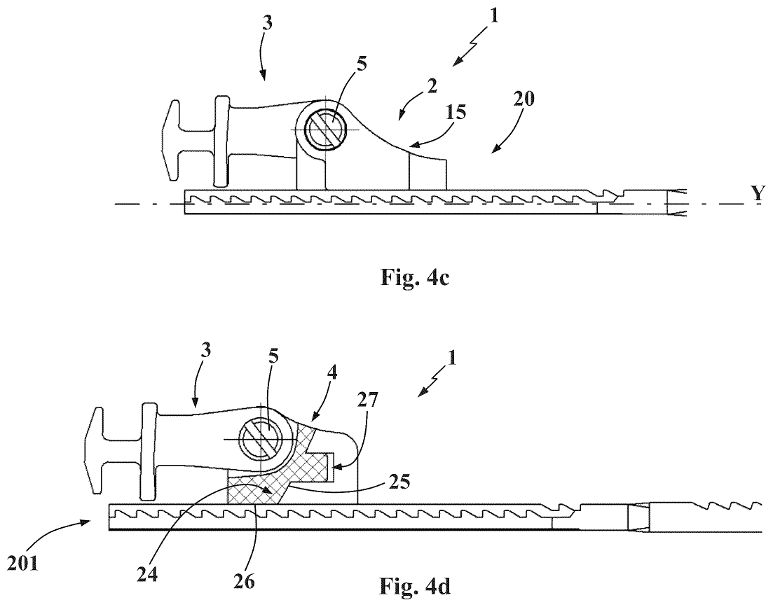

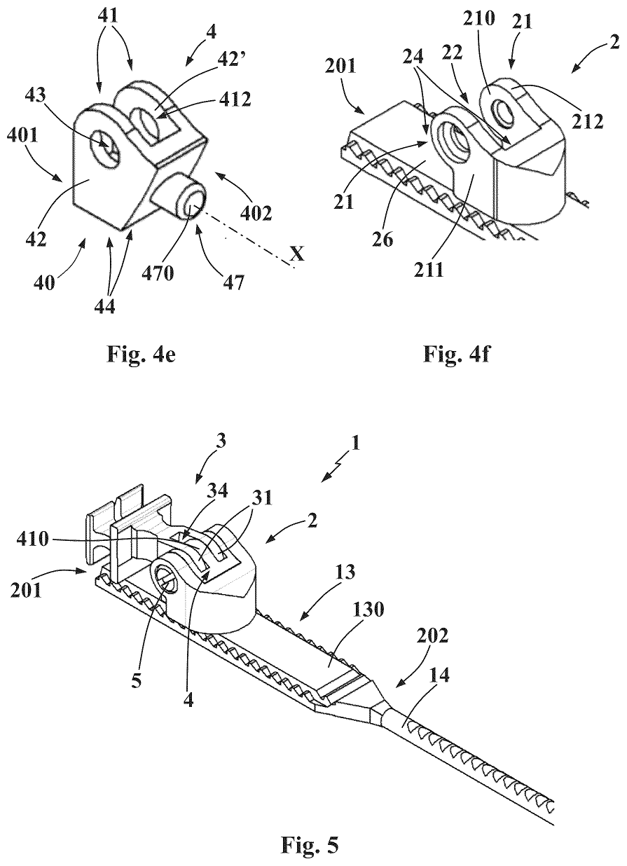

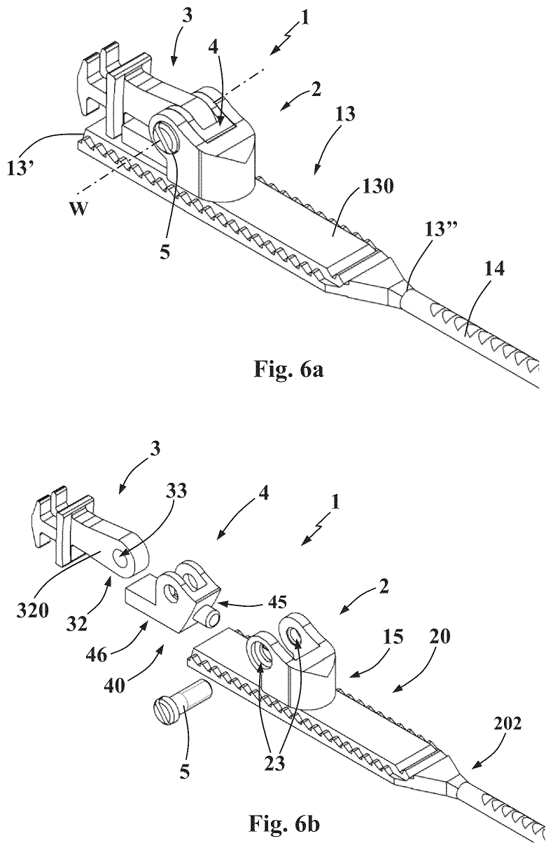

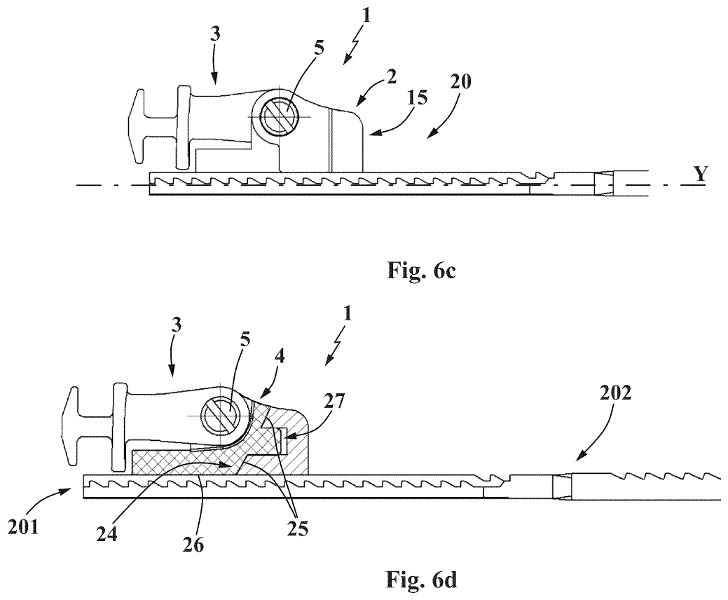

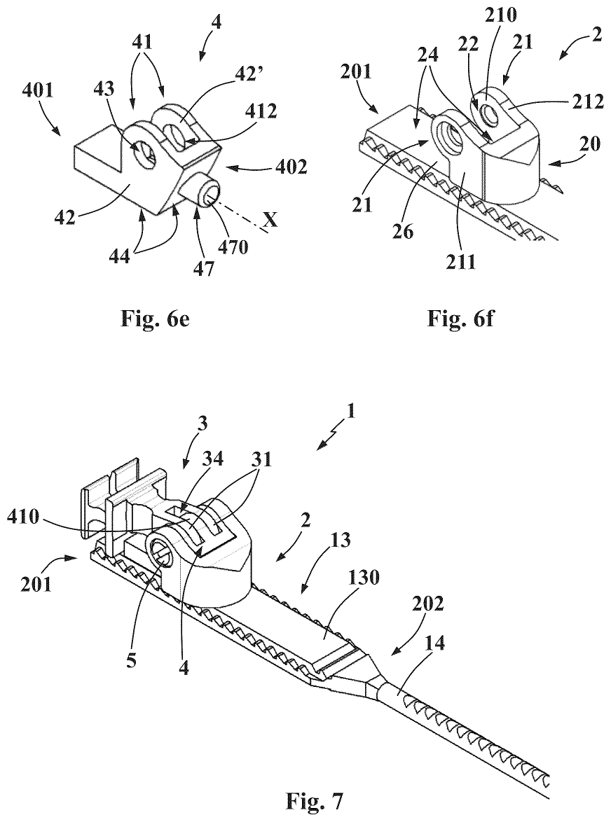

In particular, the first coupling angle is concave and the second coupling angle is convex (as in the examples of FIGS. 2a-3, 8a-10), or vice versa (as in the examples of FIGS. 4a-7). In accordance with the embodiments illustrated in the enclosed figures, the first and the second abutment faces 25, 26 are joined (at the vertex of the first coupling angle) by means of a first clear common edge (with sharp edge or sharp corner), preferably parallel to the rotation axis W. Analogously, the first and the second abutting face 45, 46 are joined (at the vertex of the second coupling angle) by means of a second clear common edge (with sharp edge or sharp corner), preferably parallel to the rotation axis W.

Otherwise, in accordance with a non-illustrated embodiment, the first and the second abutment faces 25, 26 are connected by means of a rounded first edge, and the first and the second abutting faces 45, 46 are connected by means of a rounded second edge.

Advantageously, the base body 20 is extended along an extension direction Y orthogonal to the rotation axis W between a first side 201, at which the second articulation element 2 is placed, and an opposite second side 202.

Advantageously, the base body 20 comprises a shaped portion 15, which is provided with the aforesaid first shoulders 21 and preferably an elongated plate 13 to which the shaped portion 15 is fixed.

Preferably, in accordance with the embodiments of the hinge 1 illustrated in the enclosed figures, the elongated plate 13 is extended, longitudinally, along the aforesaid extension direction Y, between a first end 13′, placed at the aforesaid first side 201 of the base body 20, and an opposite second end 13″ placed at the second side 202 of the base body 20 itself.

In particular, the elongated plate 13 is provided with an internal surface 130 which, with the hinge 1 in open position, is directed towards the elongated plate 13 of the first articulation element 2 mounted on the other temple of the eyeglasses.

Advantageously, the shaped portion 15 is fixed on the internal surface 130 of the elongated plate 13, e.g. by means of welding.

Advantageously, the elongated plate 13 is provided with an external surface which is directed opposite the internal surface 130 and is closed (lacks through openings).

Preferably, the first articulation element 2 is fixed (e.g. via welding) to a core 14 intended to be embedded in the plastic material of the temple of the frame 10. More in detail, the second end 13″ of the elongated plate 13 is intended to be fixed to the core 14, which is adapted to be forcibly inserted longitudinally within the plastic matrix of the temple.

Otherwise, with reference to a non-illustrated embodiment, the first articulation element 2 (comprising in particular only the shaped portion 15) is fixed (e.g. via welding) on the temple of the frame 10, preferably made of metal.

Otherwise, additionally, with reference to a further non-illustrated embodiment, the first articulation element 2 is intended to be partially embedded in the first component 11 (whether the latter is a temple or the end piece) of the frame 10 (preferably made of polymer material), in particular by means of anchoring portions arranged on the shaped portion 15 (with the presence of the elongated plate 13), in a per se conventional manner.

Advantageously, in accordance for example with the embodiments from the first to the fourth illustrated in FIGS. 2a-9, the base body 20 of the first articulation element 2 is engaged with the abutment portion 40 of the antifriction element 4 by means of a shape coupling obtained on the engagement surface 24 of the base body 20 and on the coupling surface 44 of the abutment portion 40.

In particular, in accordance with such embodiments from the first to the fourth, the base body 20 of the first articulation element 2 is provided with an engagement seat 27 made on the engagement surface 24.

Preferably, the abutment portion 40 of the antifriction element 4 is provided with a coupling pin 47 extended projecting from the coupling surface 44 and inserted in shape coupling in the engagement seat 27, in a manner such to define the aforesaid shape coupling.

In particular, such configuration of the engagement seat 27 and of the coupling pin 47 allows blocking in a simple manner and stops the antifriction element 4 at the first articulation element 2 already during the assembly of the hinge 1.

Advantageously, the coupling pin 47 arranged for being engaged in the engagement seat 27 facilitates the coupling of the antifriction element 4 with the first articulation element 2. Indeed, the presence of the aforesaid coupling pin 47 facilitates the task of an operator who must orient the antifriction element 4 in the correct sense in order to couple it to the first articulation element 2, with the operator who in particular is assisted, as he/she is able to place the coupling pin 47 at the engagement seat 27.

In this manner, in particular, also during the operations of storage and transport of the hinge 1 (e.g. in order to send it to the eyeglass producer), the antifriction element 4 remains firmly coupled to the first articulation element 2 even of the latter is not already hinged to the second articulation element 3 by means of the hinge pin 3.

Advantageously, in accordance with the aforesaid embodiments from the first to the fourth, the engagement seat 27 is made on the first abutment face 25 of the engagement surface 24 of the base body 20, and the coupling pin 47 is placed on the first abutting face 45 of the coupling surface 44 of the abutment portion 40.

In this manner, the coupling of the antifriction element 4 with the first articulation element 2 results facilitated, with the coupling pin 47 that is inserted in the engagement seat 27, and allows the first abutting face 45 to abut against the first abutment face 25, and the second abutting face 46 that abuts against the second abutment face 26.

Otherwise, without departing from the protective scope of the present invention, the coupling pin 47 can extend projectingly from the second abutting face 46 and the engagement seat 27 can be advantageously made on the second abutment face 26.

Advantageously, the coupling pin 47 is extended projecting from the coupling surface 44 along an extension axis X orthogonal to the rotation axis W.

Preferably, the coupling pin 47 is extended, along the extension axis X, with constant section from the coupling surface 44 up to a free end thereof 470. In accordance with a different embodiment, the coupling pin 47 comprises at least one tapered section terminating with the aforesaid free end 470.

Advantageously, the engagement seat 27 has an extension parallel to the extension axis X of the coupling pin 47, so as to facilitate the insertion of the latter in the engagement seat 27 itself. Preferably, in accordance with the first and the fourth embodiment of the hinge 1 illustrated in FIGS. 2a-3 and 8a-9, the extension axis X of the coupling pin 47 is also orthogonal to the extension direction Y of the base body 20.

In operation, so as to couple the first articulation element 2 to the antifriction element 4, the latter is placed above the first articulation element 2, and in particular opposite the elongated plate 13 with respect to the base body 20, and is then made to slide parallel to the aforesaid extension axis X, in order to insert the coupling pin 47 in the engagement seat 27.

Otherwise, in accordance with the second and the third embodiment of the hinge 1 illustrated in FIGS. 4a-7, the extension axis X along which the coupling pin 47 is extended is parallel from the extension direction Y of the base body 20, and in particular to at least one section of the first abutting face 45 of the antifriction element 4.

In this case, the antifriction element 4 is coupled to the first articulation element 2, placing it substantially at the same height as the base body 20 with respect to the elongated plate 13, at the second abutment face 26 of the engagement surface 24, and is then made to slide parallel to the extension direction Y, in order to insert the coupling pin 47 in the engagement seat 27.

Otherwise, in addition, in accordance with a non-illustrated embodiment, the coupling pin 47 can be tilted with respect to the extension direction Y as well as to a direction orthogonal to such extension direction Y.

Advantageously, the engagement seat 27 is blind, extended in particular from the engagement surface 24 of the base body 20 up to a closed bottom thereof.

In accordance with an embodiment not illustrated in the enclosed figures, the engagement seat is made on the coupling surface 44 of the abutment portion 40 of the antifriction element 4, and the coupling pin is extended projecting from the engagement surface 24 of the base body 20 of the first articulation element 2 (and is inserted in shape coupling in the engagement seat, such to define the aforesaid shape coupling).

Advantageously, the antifriction element 4 è made of polymer material, for example a self-lubricating plastic, in particular polyoxymethylene, also known with the name acetal resin or POM or, alternatively, made of Teflon.

In this manner, the antifriction element 4 is particularly set to develop a reduced friction with the first shoulders 21 of the first articulation element 2 and with the engagement head 32 of the second articulation element 3.

Advantageously, the antifriction element 4 is made in a single body, e.g. via injection. In this manner, its production and the assembly of the hinge 1 result particularly simple and inexpensive.

Otherwise, the antifriction element 4 can be made of metal material (e.g. bronze or steel), and can optionally provide for a surface coating (e.g. in molybdenum disulfide) adapted to decrease the surface roughness in order to further reduce the friction.

Advantageously, the first abutment face 25 and the second abutment face 26 of the base body 20 are placed in succession, in particular along the above-defined extension direction Y of the base body 20 itself, more in detail proceeding from the first side 201 towards the second side 202 of the base body 20.

Preferably, the antifriction element 4 is extended, according to the extension direction Y, between a third side 401, on which the arms 41 are placed, and an opposite fourth side 402. Advantageously, the first abutting face 45 and the second abutting face 46 of the antifriction element 4 are placed in succession, in particular according to the extension direction Y, more in detail proceeding from the third side 401 towards the fourth side 402 of the antifriction element 4.

Preferably, in accordance with the embodiments from the first to the third and the fifth illustrated in FIGS. 2a-7 and 10, the second abutment face 26 of the base body 20 is placed between the first side 201 and the first abutment face 25.

More in detail, in accordance with such embodiments, the second abutment face 26 is extended, at least partly, on the internal face 130 of the elongated plate 13 of the first articulation element 2, and in particular between the shaped portion 15 and the first side 201 of the base body 20. Advantageously, the first abutting face 45 of the antifriction element 4 is adjacent to the fourth side 402 and the second abutting face 46 is adjacent to the third side 401.

Preferably, the second abutting face 46 of the antifriction element 4 is placed between the first abutting face 45 and the third side 401.

Advantageously, in accordance with the first and the fifth embodiment illustrated in FIGS. 2a-3 and 10, the second abutment face 26 of the base body 20 comprises at least one first section 26′ parallel to the extension direction Y, and at least one second section 26″ transverse to the first section 26′ and placed as a connection between the first abutment face 25 and the first section 26′.

In particular, the first section 26′ and the second section 26″ delimit an engagement step 28 directed on the first side 201.

Advantageously, the abutment portion 40 of the antifriction element 4 comprises a projecting base 48, which is extended projectingly on the coupling surface 44, is engaged in the engagement step 28 and defines the second abutting face 46.

Preferably, the base 48 is abutted against the elongated plate 13, and in particular against the first section 26′ of the second abutment face 26.

In particular, the aforesaid second abutting face 46 comprises a first zone 46′, preferably parallel to the extension direction Y, placed in abutment against the first section 26′ of the second abutment face 26 and a second zone 46″, preferably transverse to the first zona 46′, placed in abutment against the second section 26″ of the second abutment face 26.

In accordance with such first and fifth embodiments, the first and the second section 26′, 26″, and preferably also the first and the second zona 46′, 46″, are connected to each other at a right angle.

Advantageously, with the second zona 46″ of the second abutting face 46 in abutment, preferably in abutment against the second section 26″, the base 48 is engage with the engagement step 28 and the antifriction element 4 is blocked in rotation relative to the first articulation element 2 during the opening and closing of the temples, thus remaining integral with the latter.

In particular, the first section 26′ of the second abutment face 26 is connected to the first abutment face 25 by means of the aforesaid first common edge.

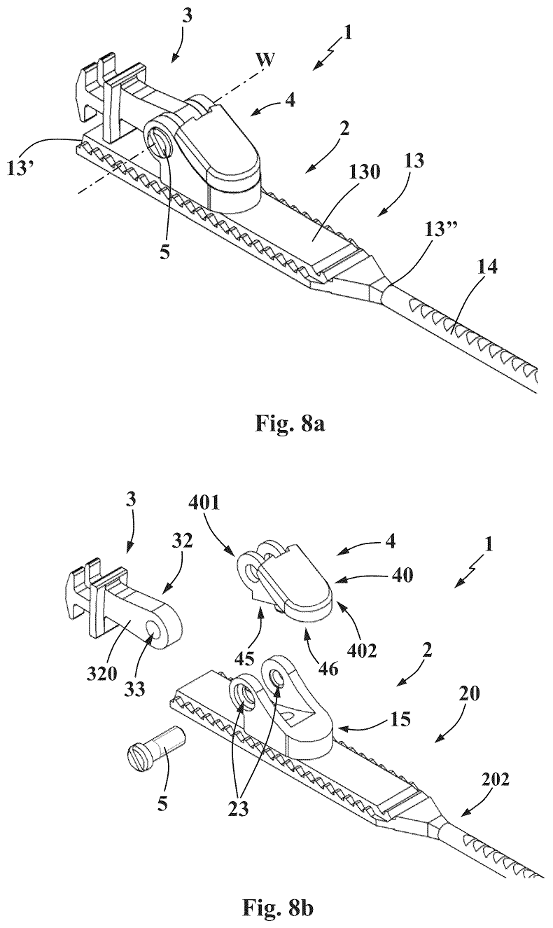

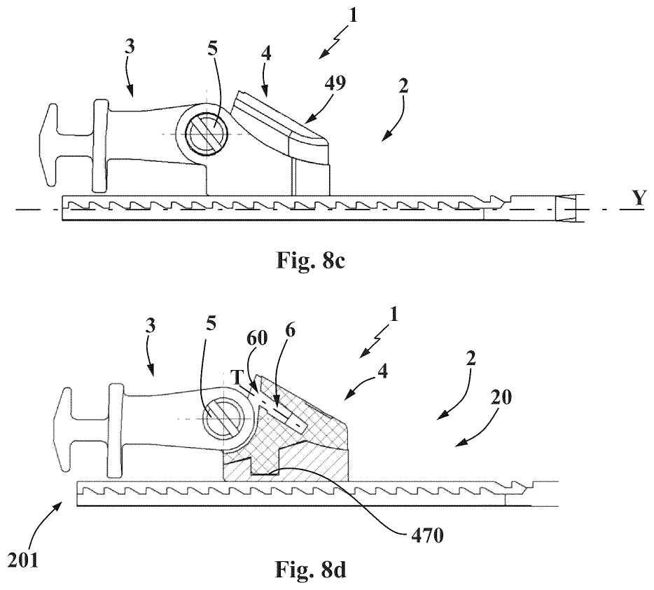

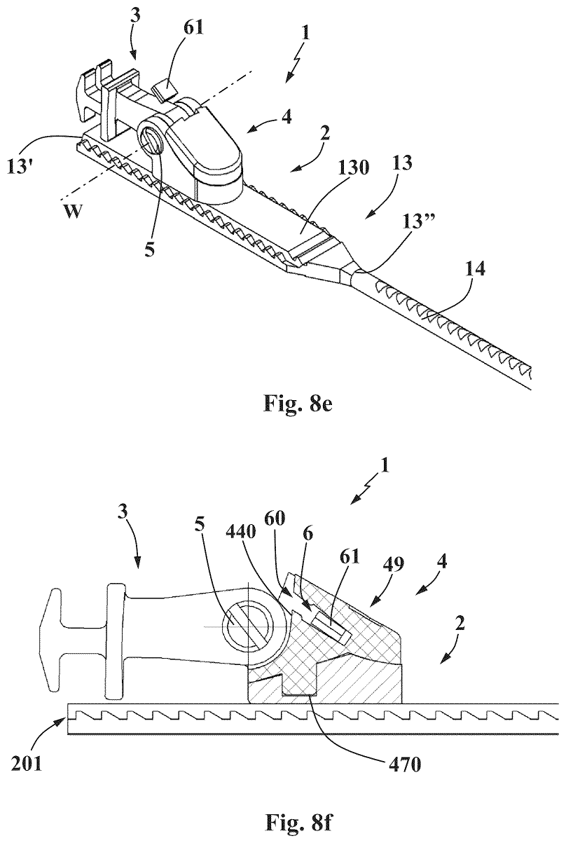

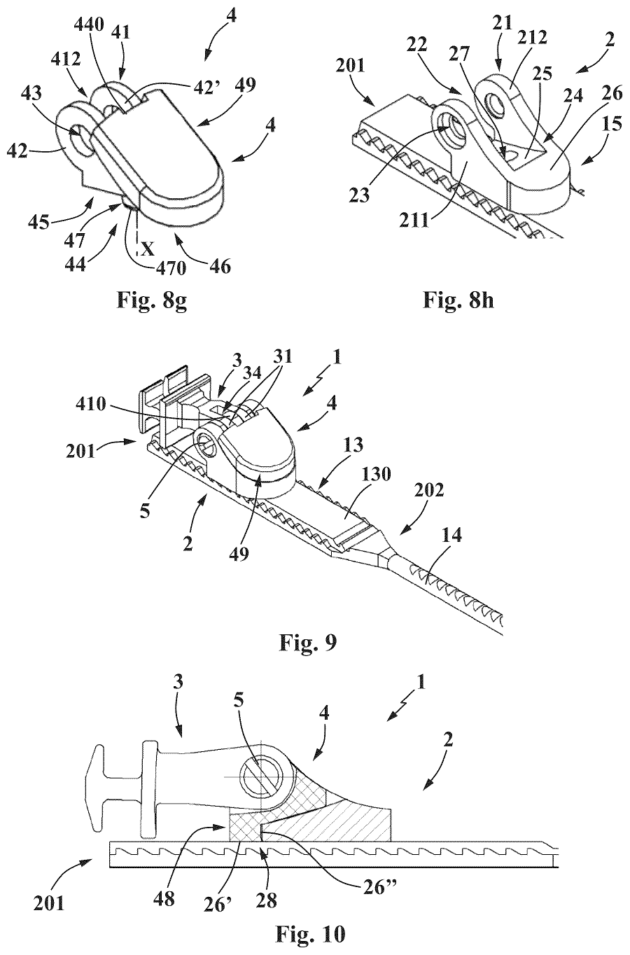

Advantageously, in accordance with the fourth embodiment of the present hinge 1 illustrated in FIGS. 8a-9, the second abutment face 26 of the base body 20 is placed between the second side 202 and the first abutment face 25.

In particular, still in accordance with such fourth embodiment, the second abutting face 46 is placed between the fourth side 402 and the first abutting face 45.

More in detail, the first abutting face 45 is adjacent to the third side 401 and the second abutting face 46 is adjacent to the fourth side 402.

Advantageously, in accordance with such fourth embodiment, the abutment portion 40 of the antifriction element 4 comprises a coverage appendage 49, which is extended projectingly on the fourth side 402 extended at least above the second abutment face 26 of the base body 20 and defines the second abutting face 46 placed in abutment against the second abutment face 26.

Advantageously, with reference to the embodiment of FIGS. 8a-9, the antifriction element 4 comprises a housing seat 6 provided with at least one opening 60 in order to insert an identification device TAG 61 in the housing seat 6.

More in detail, the identification device TAG 61 comprises an electronic component, e.g. of RFID type, susceptible of being read by an external reading device so as to transmit several pieces of information relative to the authenticity of the frame, in a manner such to distinguish the authentic products from the counterfeit ones.

Preferably, the housing seat 6 is extended, starting from its opening 60, along a housing axis T substantially orthogonal to the rotation axis W.

More in detail, the opening 60 is made on a front surface 440 of the abutment portion 40 placed above the arms 41.

In particular, the housing seat 6 is extended, at least partly, within the coverage appendage 49. In accordance with the embodiments from the first to the fifth described above, illustrated in FIGS. 2a-2f, 4a-4f, 6a-6f, 8a-8h and 10, the hinge 1 is of the type with three shoulders, wherein the first articulation element 2 is provided with two first shoulders 21 and the engagement head 32 of the second articulation element 3 is provided with only one second shoulder 31 placed between the two aforesaid first shoulders 21.

In accordance with the embodiment variants of the aforesaid embodiments from the first to the fourth, illustrated in FIGS. 3, 5, 7 and 9, the hinge 1 is of the type with five shoulders.

In particular, in accordance with such variants, the antifriction element 4 is provided with an intermediate arm 410, which is placed between two arms 41 equidistant from each latter, such to define two first slits 412, and is provided with a fourth through hole aligned with the aforesaid third holes 43 of the arms 41.

Advantageously, in accordance with such embodiments variants, the engagement head 32 of the second articulation element 3 comprises two second shoulders 31, each provided with a corresponding second hole 33 and placed in the slit 22 of the first articulation element 2 and, in particular, in the corresponding first slits 412 of the antifriction element 4 placed in the slit 22.

More in detail, the two second shoulders 31 are parallel to each other and between them define a second slit 34, within which the intermediate arm 410 of the antifriction element 4 is placed. Suitably, the present invention is applicable both to non-elastic hinges (such as those of the embodiments of the enclosed figures) and to elastic hinges.

The invention thus conceived therefore attains the pre-established objects.

The contents of the Italian patent application number 102023000020064, from which this application claims priority, are incorporated herein by reference.

1. Hinge for eyeglasses, which comprises:
a first articulation element (2), which is intended to be mounted on a first component (11) of an eyeglass frame (10), and comprises a base body (20), and two first shoulders (21), which are extended projectingly from said base body (20) parallel to each other, between them defining a slit (22), and are provided with corresponding first holes (23) that are aligned with each other;
a second articulation element (3), which is intended to be mounted on a second component (12) of said eyeglass frame (10), and comprises an engagement head (32) provided with at least one second hole (33) and placed in the slit (22) of said first articulation element (2) with said at least one second hole (33) aligned with said first holes (23);
an antifriction element (4), which comprises an abutment portion (40), and two arms (41), which are projectingly extended from said abutment portion (40) parallel to and spaced from each other, and are provided with corresponding third holes (43) that are aligned with each other;
wherein said antifriction element (4) is placed in the slit (22) of said first articulation element (2) with said abutment portion (40) in abutment against said base body (20), with each said arm (41) interposed between a corresponding said first shoulder (21) of said first articulation element (2) and the engagement head (32) of said second articulation element (3), and with said third hole (43) aligned with said first holes (23) and with said at least one second hole (33);
a hinge pin (5), which is inserted in the first holes (23) of the first shoulders (21) of said first articulation element (2), in the second hole (33) of the engagement head (32) of said second articulation element (3) and in the third holes (43) of the arms (41) of said antifriction element (4), and rotatably couples said first articulation element (2) and said second articulation element (3) around a rotation axis (W) passing through said first holes (23) and said at least one second hole (33) and said third holes (43);
wherein:
the base body (20) of said first articulation element (2) is provided with a shaped engagement surface (24), and the abutment portion (40) of said antifriction element (4) is provided with a coupling surface (44), which is counter-shaped with respect to said engagement surface (24) and is coupled in contact with said engagement surface (24);
the engagement surface (24) of said base body (20) is provided with a first abutment face (25) extended between said first shoulders (21) as a rear delimitation of said slit (22), and with a second abutment face (26) adjacent to said first abutment face (25), tilted with respect to said first abutment face (25) and placed outside said slit (22);
the coupling surface (44) of said abutment portion (40) is provided with a first abutting face (45) placed in abutment against said first abutment face (25), and with a second abutting face (46) adjacent to said first abutting face (45), tilted with respect to said first abutting face (45) and placed in abutment against said second abutment face (26).

2. Hinge for eyeglasses according to claim 1, wherein the base body (20) of said first articulation element (2) is engaged with the abutment portion (40) of said antifriction element (4) by means of a shape coupling obtained on the engagement surface (24) of said base body (20) and on the coupling surface (44) of said abutment portion (40).

3. Hinge for eyeglasses according to claim 2, wherein the base body (20) of said first articulation element (2) is provided with an engagement seat (27) made on said engagement surface (24), and the abutment portion (40) of said antifriction element (4) is provided with a coupling pin (47) extended projectingly from said coupling surface (44) and inserted in shape coupling in said engagement seat (27).

4. Hinge for eyeglasses according to claim 3, wherein said engagement seat (27) is made on the first abutment face (25) of the engagement surface (24) of said base body (20), and said coupling pin (47) is placed on the first abutting face (45) of the coupling surface (44) of said abutment portion (40).

5. Hinge for eyeglasses according to claim 3, characterized in that said coupling pin (47) is extended projectingly along an extension axis (X) orthogonally to said rotation axis (W).

6. Hinge for eyeglasses according to claim 1, wherein said antifriction element (4) is made of polymer material.

7. Hinge for eyeglasses according to claim 1, wherein said base body (20) is extended at least along an extension direction (Y) orthogonal to said rotation axis (W) between a first side (201), at which said second articulation element (2) is arranged, and an opposite second side (202);
wherein the first abutment face (25) and the second abutment face (26) of said base body (20) are placed in succession along said extension direction (Y);
wherein said antifriction element (4) is extended, according to said extension direction (Y), between a third side (401), on which said arms (41) are placed, and an opposite fourth side (402);
wherein the first abutting face (45) and the second abutting face (46) of said antifriction element (4) are placed in succession according to said extension direction (Y).

8. Hinge for eyeglasses according to claim 7, wherein the second abutment face (26) of said base body (20) is placed between said first side (201) and said first abutment face (25);
wherein the second abutting face (46) of said antifriction element (4) is placed between said first abutting face (45) and said third side (401).

9. Hinge for eyeglasses according to claim 8, wherein the second abutment face (26) of said base body (20) comprises at least one first section (26′) parallel to said extension direction (Y), and at least one second section (26″) transverse to said first section (26′) and placed as a connection between said first abutment face (25) and said first section (26′); wherein said first section (26′) and said second section (26″) delimit an engagement step (28) directed on said first side (201);
wherein the abutment portion (40) of said antifriction element (4) comprises a projecting base (48), which is extended projectingly on said coupling surface (44), is engaged in said engagement step (28) and defines said second abutting face (46); wherein said second abutting face (46) comprises a first zone (46′) placed in abutment against the first section (26′) of said second abutment face (26) and a second zone (46″) placed in abutment against the second section (26″) of said second abutment face (26).

10. Hinge for eyeglasses according to claim 7, wherein the second abutment face (26) of said base body (20) is placed between said second side (202) and said first abutment face (25); wherein said second abutting face (46) is placed between said fourth side (402) and said first abutting face (45).

11. Hinge for eyeglasses according to claim 10, wherein the abutment portion (40) of said antifriction element (4) comprises a coverage appendage (49), which is extended projectingly on said fourth side (402) extended at least above the second abutment face (26) of said base body (20) and defines said second abutting face (46) placed in abutment against said second abutment face (26).
